(19) United States
(12) Patent Application Publication
(10) Pub. No.: US 2010/0238021 A1
(43) Pub. Date: Sep. 23, 2010

(54) Dispenser system

(76) Inventor: Natalie Harris, London (GB)

Correspondence Address: SMITH, GAMBRELL & RUSSELL, 1130 CONNECTICUT AVENUE, N.W., SUITE 1130, WASHINGTON, DC, 20036, US

(21) Appl. No.: 12/308,669

(22) PCT Filed: Jun. 21, 2007
(86) PCT No.: PCT/GB2007/002320

§ 371 Date: Dec. 19, 2008

(30) Foreign Application Priority Data
Jun. 21, 2006 (GB) 0612332.7

(51) Int. Cl. G08B 1/08; G08B 23/00

(52) U.S. Cl. 340/539.11; 340/573.1; 235/375; 222/52

(57) ABSTRACT

A dispenser system (1) comprises a vibrating alarm (8), a visible alarm (9) and a radio frequency identification (RFID) detector (28) for detecting an RFID tag (12). When the RFID detector (28) detects the RFID tag (12) a control circuit (30) triggers the alarms (8, 9). The alarms (8, 9) are deactivated when a push button (13) is pressed, dispensing anti-bacterial hand cleanser from a reservoir (23) through a nozzle (17).

This invention relates to a dispenser system. In particular, it relates to an anti-bacterial hand cleanser dispenser system.

Nosocomial infections, otherwise known as hospital-acquired infections, are infections developed in users of healthcare establishments, such as hospitals, while attending the healthcare establishment. Nosocomial infections are of concern to healthcare providers as they increase the residency of patients at healthcare establishments and hence increase the cost of caring for patients. Furthermore, nosocomial infections can be fatal, for example if a patient contracts Methicillin-Resistant Staphylococcus Aureus (MRSAS).

Nosocomial infections are spread by physical contact between users of healthcare establishments and in particular by physical contact between healthcare professionals and patients. As patients admitted to healthcare establishments with a primary illness often have a weakened immune system, they are particularly vulnerable to secondary nosocomial infections which are carried around healthcare establishments by healthy healthcare professionals.

In recent years healthcare providers have addressed the threat of nosocomial infections by establishing hygiene policies in an attempt to reduce the transfer of nosocomial infections from healthcare professional to patients. Such policies typically specify that hands that are visibly soiled should be washed using soap and water and hands that are not visibly soiled should be decontaminated immediately before each episode of direct patient contact or care and after any activity or contact that could potentially result in hands becoming contaminated by using an anti-bacterial hand cleanser.

To support this policy anti-bacterial hand cleanser dispensers are provided throughout healthcare establishments. Anti-bacterial hand cleanser products typically take the form of an alcohol-based gel. In order to effectively decontaminate the hands, the cleanser must be applied to all surfaces of the hand and the hands must be rubbed together vigorously until the gel has evaporated and the hands are dry. Anti-bacterial hand cleanser dispensers are preferably provided at each point of care or, where more convenient, healthcare professionals are provided with personal dispensers that can be carried in a pocket or attached to clothing.

Despite the establishment of these policies within healthcare establishments and the increased provision of anti-bacterial hand cleanser dispensers, nosocomial infections have not been eliminated. This is in part due to the inconvenience of repeated thorough hand decontamination which means that healthcare professionals often do not conform to the specific strict decontamination regime.

It is a preferred aim of this invention to provide an improved dispenser which encourages healthcare professionals to conform to hand decontamination guidelines.

According to a first aspect of the invention there is provided a dispenser system comprising detecting means; alarm means activatable when the detecting means detects a target: and dispensing means for dispensing in response to the alarm means.

The system may further comprise dispensing actuation means for actuating the dispensing means. The dispensing actuation means may comprise a push button.

The system may further comprise alarm deactivation means for deactivating the alarm means. The alarm deactivation means may comprise a push button.

The alarm deactivation means and the dispensing actuation means may comprise the same push button. A single button activating both the dispensing means and the alarm deactivation means ensures that deactivating the alarm also causes the dispensing means to dispense.

Alternatively, the dispensing actuation means and the alarm deactivation means may each be comprised of separate push buttons. Instead of a push button or buttons, other known actuating mechanisms can be used.

The detecting means may comprise a radio frequency identification (RFID) tag detector and the target may be an RFID tag. RFID technology provides a convenient detecting mechanism as RFID tags are relatively cheap and small. The RFID tag may be a passive RFID tag. Passive RFID tags do not require their own power supply, which means that a passive RFID tag is relatively cheap and small.

In other embodiments, the RFID tag may be an active tag or a semi-passive tag.

In healthcare environments, the target (e.g. RFID tag) may be provided, for example, as a wristband worn by a target patient, or it may be affixed to an item of equipment in proximity to a target patient e.g. it may be fixed to the target patient's bed.

Preferably the alarm means and dispensing means are contained in a single unit which may be carried by a user e.g. a healthcare professional.

The detecting means may comprise a transceiver associated with the alarm means and a transceiver associated with the target. Alternatively, the detecting means may comprise a transceiver associated with the alarm means and a transceiver associated with the dispensing means. The transceiver may operate using conventional radio communications techniques.

The detecting means may comprise detecting means other than RFID based technology, for example other means of electromagnetic based technology such as Bluetooth® or infrared signals.

The alarm means may comprise one or more of a visible alarm, an audible alarm and a vibrating alarm.

The system may further comprise control means for controlling the detecting means and the alarm means. The control means may comprise a control circuit and/or a microprocessor. The control means may be operable to activate the alarm means each time the detecting means detects a target within a predetermined distance. In this manner, each time a different target is detected the alarm means will be activated. The control means may be operable to activate the alarm means at a predetermined time after the detecting means detects a target. In this manner, if a healthcare professional using the dispenser system attends to a patient (target) for a protracted period of time, they will be periodically reminded to decontaminate their hands. The control means may be operable to deactivate the alarm in response to the alarm deactivation means.

In many situations, a user e.g. a healthcare professional can predict in advance when the alarm means will be activated e.g. upon approach to a new target (patient) and the user may wish to deactivate the alarm means before the alarm is activated. To allow for this, the control means may be operable to prevent the alarm means from being activated if the alarm deactivation means is actuated in response to actuation of the dispensing means within a predetermined time before detection of the target. For example, if a healthcare professional approaches a new patient and dispenses e.g. a hygiene gel on approach (but before the detecting means detects the new patient (target)), the alarms control means will allow deactivation of the alarm means provided that the target is detected within a short period of time (e.g. 1 minute).

The control means may be used for conformance monitoring e.g. to check that healthcare professionals are conforming to hand decontamination guidelines. For example, the control means may record the number of targets detected by a user, the length of time spent with any one target and the number times that dispense e.g. of a hygiene product occurs. If there is a discrepancy between the data, it can be assumed that there is non-compliance.

Preferably, the dispenser is for dispensing a hygiene product, and the alarm deactivation means is operable to deactivate the alarm means when a hygiene product is dispensed from the dispensing means and/or the dispense actuation means is operable to dispense a hygiene product actuate in response to deactivation of the alarm means.

The system may further comprise means for receiving a hygiene product. The hygiene product may be in a removable container. The hygiene product may be a liquid, gel, solid or powder. The hygiene product may be an anti-bacterial hand rub gel.

The system may further comprise mounting means for mounting at least part of the dispenser system on a garment. The mounting means may comprise a surface fastener and/or the mounting means may comprise a hook or loop for mounting the at least part of the dispenser system on a belt. The mounting means may be associated with the dispensing means and/or with the alarm means.

According to a second aspect of the present invention, there is provided a dispenser system comprising:
detecting means;
alarm means activatable when the detecting means detects a target;
alarm deactivation means for deactivating the alarm means; and
dispense actuation means for actuating dispensing means,
wherein the dispense actuation means is operable to actuate the dispensing means in response to deactivation of the alarm means and/or the alarm deactivation means is operable to deactivate the alarm means in response to actuation of the dispensing means.

The second aspect of the invention provides a system in which deactivation of the alarm means and actuation of the dispensing means are interdependent i.e. deactivation of the alarm means triggers dispense and/or dispense triggers deactivation of the alarm. This means that a user, e.g. a healthcare professional cannot simply deactivate the alarms means without dispensing e.g. a hygiene product because deactivation of the alarm means triggers the actuation of the dispensing means. It also allows a user, e.g. a healthcare professional to deactivate the alarm means by dispensing e.g. a hygiene product either before or after the alarm means has been activated.

The dispensing actuation means may comprise a push button or some other known actuating mechanism.

The alarm deactivation means may comprise a push button or some other known actuating mechanism.

The alarm deactivation means and the dispensing actuation means preferably comprise the same push button/known actuating mechanism. A single button/actuating mechanism activating both the dispensing means and the alarm deactivation means facilitates simultaneous deactivation of the alarm and dispense.

Alternatively, the dispensing actuation means and the alarm deactivation means may each be comprised of separate push buttons/known actuating mechanisms.

The detecting means may comprise a radio frequency identification (RFID) tag detector and the target may be an RFID tag. RFID technology provides a convenient detecting mechanism as RFID tags are relatively cheap and small. The RFID tag may be a passive RFID tag. Passive RFID tags do not require their own power supply, which means that a passive RFID tag is relatively cheap and small.

The RFID tag may be an active tag or a semi-passive tag.

In healthcare environments, the target (e.g. RFID tag) may be provided, for example, as a wristband worn by a target patient, or it may be affixed to an item of equipment in proximity to a target patient e.g. it may be fixed to the target patient's bed.

Preferably the alarm means and dispensing means are contained in a single unit which may be carried by a user e.g. a healthcare professional.

The detecting means may comprise a transceiver associated with the alarm means and a transceiver associated with the target. Alternatively, the detecting means may comprise a transceiver associated with the alarm means and a transceiver associated with the dispensing means. The transceiver may operate using conventional radio communications techniques.

The detecting means may comprise detecting means other than RFID based technology, for example other means of electromagnetic based technology such as Bluetooth® or infrared signals.

The alarm means may comprise one or more of a visible alarm, an audible alarm and a vibrating alarm.

The system may further comprise control means for controlling the detecting means and the alarm means. The control means may comprise a control circuit and/or a microprocessor. The control means may be operable to activate the alarm means each time the detecting means detects a target within a predetermined distance. In this manner, each time a different target is detected the alarm means will be activated. The control means may be operable to activate the alarm means at a predetermined time after the detecting means detects a target. In this manner, if a healthcare professional using the dispenser system attends to a patient (target) for a protracted period of time, they will be periodically reminded to decontaminate their hands. The control means may be operable to deactivate the alarm in response to the alarm deactivation means.

In many situations, a user e.g. a healthcare professional can predict in advance when the alarm means will be activated e.g. upon approach to a new target (patient) and the user may wish to deactivate the alarm means before the alarm is activated. To allow for this, the control means may be operable to prevent the alarm means from being activated if the alarm deactivation means is actuated in response to actuation of the dispensing means within a predetermined time before detection of the target. For example, if a healthcare professional approaches a new patient and dispenses e.g. a hygiene gel on approach (but before the detecting means detects the new patient (target)), the alarms control means will allow deactivation of the alarm means provided that the target is detected within a short period of time (e.g. 1 minute).

The control means may be used for conformance monitoring e.g. to check that healthcare professionals are conforming to hand decontamination guidelines. For example, the control means may record the number of targets detected by a user, the length of time spent with any one target and the number times that dispense e.g. of a hygiene product occurs. If there is a discrepancy between the data, it can be assumed that there is non-compliance.

Preferably, the dispenser is for dispensing a hygiene product, and the alarm deactivation means is operable to deactivate the alarm means when a hygiene product is dispensed from the dispensing means and/or the dispense actuation means is operable to dispense a hygiene product actuate in response to deactivation of the alarm means.

The system may further comprise means for receiving a hygiene product. The hygiene product may be in a removable container. The hygiene product may be a liquid, gel, solid or powder. The hygiene product may be an anti-bacterial hand rub gel.

The system may further comprise mounting means for mounting at least part of the dispenser system on a garment. The mounting means may comprise a surface fastener and/or the mounting means may comprise a hook or loop for mounting the at least part of the dispenser system on a belt. The mounting means may be associated with the dispensing means and/or with the alarm means.

According to a third aspect of the invention there is provided a dispenser for dispensing a hygiene product, the dispenser comprising: detecting means; alarm means activatable when the detecting means detects a target; dispensing means for dispensing hygiene product; and alarm deactivation means for deactivating the alarm means when a hygiene product is dispensed from the dispensing means.

The system may further comprise dispensing actuation means for actuating the dispensing means. The dispensing actuation means may comprise a push button or some other known actuating mechanism.

The alarm deactivation means may comprise a push button or some other known actuating mechanism.

The alarm deactivation means and the dispensing actuation means may comprise the same push button/actuating mechanism. A single button/actuating mechanism activating both the dispensing means and the alarm deactivation means ensures that deactivating the alarm also causes the dispensing means to dispense.

Alternatively, the dispensing actuation means and the alarm deactivation means may each be comprised of separate push buttons/known actuating mechanisms.

The detecting means may comprise a radio frequency identification (RFID) tag detector and the target may be an RFID tag. RFID technology provides a convenient detecting mechanism as RFID tags are relatively cheap and small. The RFID tag may be a passive RFID tag. Passive RFID tags do not require their own power supply, which means that a passive RFID tag is relatively cheap and small.

In other embodiments, the RFID tag may be an active tag or a semi-passive tag.

In healthcare environments, the target (e.g. RFID tag) may be provided, for example, as a wristband worn by a target patient, or it may be affixed to an item of equipment in proximity to a target patient e.g. it may be fixed to the target patient's bed.

Preferably the alarm means and dispensing means are contained in a single unit which may be carried by a user e.g. a healthcare professional.

The detecting means may comprise a transceiver associated with the alarm means and a transceiver associated with the target. Alternatively, the detecting means may comprise a transceiver associated with the alarm means and a transceiver associated with the dispensing means. The transceiver may operate using conventional radio communications techniques.

The detecting means may comprise detecting means other than RFID based technology, for example other means of electromagnetic based technology such as Bluetooth® or infrared signals.

The alarm means may comprise one or more of a visible alarm, an audible alarm and a vibrating alarm.

The system may further comprise control means for controlling the detecting means and the alarm means. The control means may comprise a control circuit and/or a microprocessor. The control means may be operable to activate the alarm means each time the detecting means detects a target within a predetermined distance. In this manner, each time a different target is detected the alarm means will be activated. The control means may be operable to activate the alarm means at a predetermined time after the detecting means detects a target. In this manner, if a healthcare professional using the dispenser system attends to a patient (target) for a protracted period of time, they will be periodically reminded to decontaminate their hands. The control means may be operable to deactivate the alarm in response to the alarm deactivation means.

In many situations, a user e.g. a healthcare professional can predict in advance when the alarm means will be activated e.g. upon approach to a new target (patient) and the user may wish to deactivate the alarm means before the alarm is activated. To allow for this, the control means may be operable to prevent the alarm means from being activated if the alarm deactivation means is actuated in response to actuation of the dispensing means within a predetermined time before detection of the target. For example, if a healthcare professional approaches a new patient and dispenses e.g. a hygiene gel on approach (but before the detecting means detects the new patient (target)), the alarms control means will allow deactivation of the alarm means provided that the target is detected within a short period of time (e.g. 1 minute).

The control means may be used for conformance monitoring e.g. to check that healthcare professionals are conforming to hand decontamination guidelines. For example, the control means may record the number of targets detected by a user, the length of time spent with any one target and the number times that dispense e.g. of a hygiene product occurs. If there is a discrepancy between the data, it can be assumed that there is non-compliance.

The system may further comprise means for receiving a hygiene product. The hygiene product may be in a removable container. The hygiene product may be a liquid, gel, solid or powder. The hygiene product may be an anti-bacterial hand rub gel.

The system may further comprise mounting means for mounting at least part of the dispenser system on a garment. The mounting means may comprise a surface fastener and/or the mounting means may comprise a hook or loop for mounting the at least part of the dispenser system on a belt. The mounting means may be associated with the dispensing means and/or with the alarm means.

According to a fourth aspect of the invention there is provided a dispenser system comprising: a dispenser and an alarm unit, wherein the dispenser comprises dispensing means, and wherein the alarm unit comprises detecting means for detecting the dispenser and alarm means activatable when the detecting means detects the dispenser.

The detecting means may comprise a first transceiver; and the dispenser may comprise a second transceiver for communicating with the first transceiver.

The alarm means may be activatable when the first transceiver receives a first signal from the second transceiver.

The alarm means may be deactivatable when the first transceiver receives a second signal from the second transceiver. The second signal may be sent when the dispensing means dispenses a substance.

The transceivers may operate using conventional radio communications techniques or other means of electromagnetic based technology such as Bluetooth® or infrared signals.

The system may further comprise dispensing actuation means for actuating the dispensing means. The dispensing actuation means may comprise a push button or other known actuation mechanism.

The system may further comprise alarm deactivation means for deactivating the alarm means. The alarm deactivation means may comprise a push button or other known actuation mechanism.

In healthcare environments, the alarm unit may be provided adjacent a patient e.g. affixed to the patients bed. The dispenser may be carried by a healthcare professional. Alternatively, the dispenser may be provided adjacent a patient e.g. affixed to the patient's bed and the alarm unit may be carried by the healthcare professional.

The alarm means may comprise one or more of a visible alarm, an audible alarm and a vibrating alarm.

The system may further comprise control means for controlling the detecting means and the alarm means. The control means may comprise a control circuit and/or a microprocessor. The control means may be operable to activate the alarm means each time the detecting means detects a dispenser within a predetermined distance. In this manner, each time a different dispenser is detected the alarm means will be activated. The control means may be operable to activate the alarm means at a predetermined time after the detecting means detects a dispenser. In this manner, if a healthcare professional using the dispenser system attends to a patient for a protracted period of time, they will be periodically reminded to decontaminate their hands. The control means may be operable to deactivate the alarm in response to the alarm deactivation means.

In many situations, a user e.g. a healthcare professional can predict in advance when the alarm means will be activated e.g. upon approach to a new dispenser/alarm unit and the user may wish to deactivate the alarm means before the alarm is activated. To allow for this, the control means may be operable to prevent the alarm means from being activated if the alarm deactivation means is actuated in response to actuation of the dispensing means within a predetermined time before detection of the dispenser by the detecting means. For example, if a healthcare professional approaches a new dispenser or alarm unit and dispenses e.g. a hygiene gel on approach (but before the detecting means detects the dispenser, the alarms control means will allow deactivation of the alarm means provided that the dispenser is detected within a short period of time (e.g. 1 minute).

The control means may be used for conformance monitoring e.g. to check that healthcare professionals are conforming to hand decontamination guidelines. For example, the control means may record the number of dispensers detected by a user, the length of time spent with any patient adjacent a dispenser and the number times that dispense e.g. of a hygiene product occurs. If there is a discrepancy between the data, it can be assumed that there is non-compliance.

Preferably, the dispenser is for dispensing a hygiene product, and the alarm deactivation means is operable to deactivate the alarm means when a hygiene product is dispensed from the dispensing means and/or the dispense actuation means is operable to dispense a hygiene product actuate in response to deactivation of the alarm means.

The dispenser may further comprise means for receiving a hygiene product. The hygiene product may be in a removable container. The hygiene product may be a liquid, gel, solid or powder. The hygiene product may be an anti-bacterial hand rub gel.

The system may further comprise mounting means for mounting either the dispenser or the alarm unit on a garment. The mounting means may comprise a surface fastener and/or the mounting means may comprise a hook or loop for mounting the at least part of the dispenser system on a belt.

According to a fifth aspect of the invention there is provided a dispenser system comprising a dispenser and a separate alarm unit, the dispenser comprising:
dispense actuation means for actuating dispensing means, and the alarm unit comprising:
detecting means for detecting the dispenser;
alarm means activatable when the detecting means detects the dispenser; and
alarm deactivation means for deactivating the alarm means,
   wherein the dispense actuation means is operable to actuate the dispensing means in response to deactivation of the alarm means and/or the alarm deactivation means is operable to deactivate the alarm means in response to actuation of the dispensing means.

The fifth aspect of the invention provides a system in which deactivation of the alarm means and actuation of the dispensing means are interdependent i.e. deactivation of the alarm means triggers dispense and/or dispense triggers deactivation of the alarm. This means that a user, e.g. a healthcare professional cannot simply deactivate the alarms means without dispensing e.g. a hygiene product because deactivation of the alarm means triggers the actuation of the dispensing means. It also allows a user, e.g. a healthcare professional to deactivate the alarm means by dispensing e.g. a hygiene product either before or after the alarm means has been activated.

The detecting means may comprise a first transceiver; and the dispenser may comprise a second transceiver for communicating with the first transceiver.

The alarm means may be activatable when the first transceiver receives a first signal from the second transceiver.

The alarm means may be deactivatable when the first transceiver receives a second signal from the second transceiver. The second signal may be sent when the dispensing means dispenses a substance.

The transceivers may operate using conventional radio communications techniques or other means of electromagnetic based technology such as Bluetooth® or infrared signals.

The dispensing actuation means may comprise a push button or some other known actuating mechanism.

The alarm deactivation means may comprise a push button or some other known actuating mechanism.

In healthcare environments, the alarm unit may be provided adjacent a patient e.g. affixed to the patients bed. The dispenser may be carried by a healthcare professional. Alternatively, the dispenser may be provided adjacent a patient e.g. affixed to the patient's bed and the alarm unit may be carried by the healthcare professional.

The alarm means may comprise one or more of a visible alarm, an audible alarm and a vibrating alarm.

The system may further comprise control means for controlling the detecting means and the alarm means. The control means may comprise a control circuit and/or a microprocessor. The control means may be operable to activate the alarm means each time the detecting means detects a dispenser within a predetermined distance. In this manner, each time a different dispenser is detected the alarm means will be activated. The control means may be operable to activate the alarm means at a predetermined time after the detecting means detects a dispenser. In this manner, if a healthcare professional using the dispenser system attends to a patient for a protracted period of time, they will be periodically reminded to decontaminate their hands. The control means may be operable to deactivate the alarm in response to the alarm deactivation means.

In many situations, a user e.g. a healthcare professional can predict in advance when the alarm means will be activated e.g. upon approach to a new dispenser/alarm unit and the user may wish to deactivate the alarm means before the alarm is activated. To allow for this, the control means may be operable to prevent the alarm means from being activated if the alarm deactivation means is actuated in response to actuation of the dispensing means within a predetermined time before detection of the dispenser by the detecting means. For example, if a healthcare professional approaches a new dispenser or alarm unit and dispenses e.g. a hygiene gel on approach (but before the detecting means detects the dispenser, the alarms control means will allow deactivation of the alarm means provided that the dispenser is detected within a short period of time (e.g. 1 minute).

The control means may be used for conformance monitoring e.g. to check that healthcare professionals are conforming to hand decontamination guidelines. For example, the control means may record the number of dispensers detected by a user, the length of time spent with any patient adjacent a dispenser and the number times that dispense e.g. of a hygiene product occurs. If there is a discrepancy between the data, it can be assumed that there is non-compliance.

Preferably, the dispenser is for dispensing a hygiene product, and the alarm deactivation means is operable to deactivate the alarm means when a hygiene product is dispensed from the dispensing means and/or the dispense actuation means is operable to dispense a hygiene product actuate in response to deactivation of the alarm means.

The dispenser may further comprise means for receiving a hygiene product. The hygiene product may be in a removable container. The hygiene product may be a liquid, gel, solid or powder. The hygiene product may be an anti-bacterial hand rub gel.

The system may further comprise mounting means for mounting either the dispenser or the alarm unit on a garment. The mounting means may comprise a surface fastener and/or the mounting means may comprise a hook or loop for mounting the at least part of the dispenser system on a belt.

According to a further aspect of the invention there is provided a method of prompting hand decontamination, the method comprising the steps of: providing alarm means; activating the alarm means when hand decontamination is required; and providing dispensing means for dispensing a hygiene product in response to activation of the alarm means.

The method may further comprise deactivating the alarm means when a hygiene product is dispensed from the dispensing means.

The alarm means may be activated each time a healthcare professional carrying the alarm means or dispensing means approaches a consecutively different patient or each time a healthcare professional approaches a consecutively different patient associated with the alarm means or dispensing means. The alarm means may be activated after a predetermined time.

The invention will be further described by way of example with reference to the accompanying drawings in which:

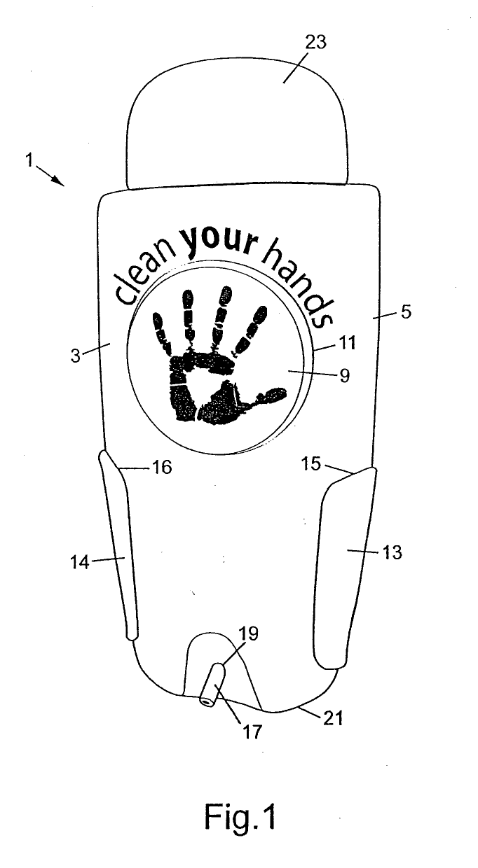

FIG. 1 is a perspective view of a dispenser in accordance with a first embodiment of the invention;

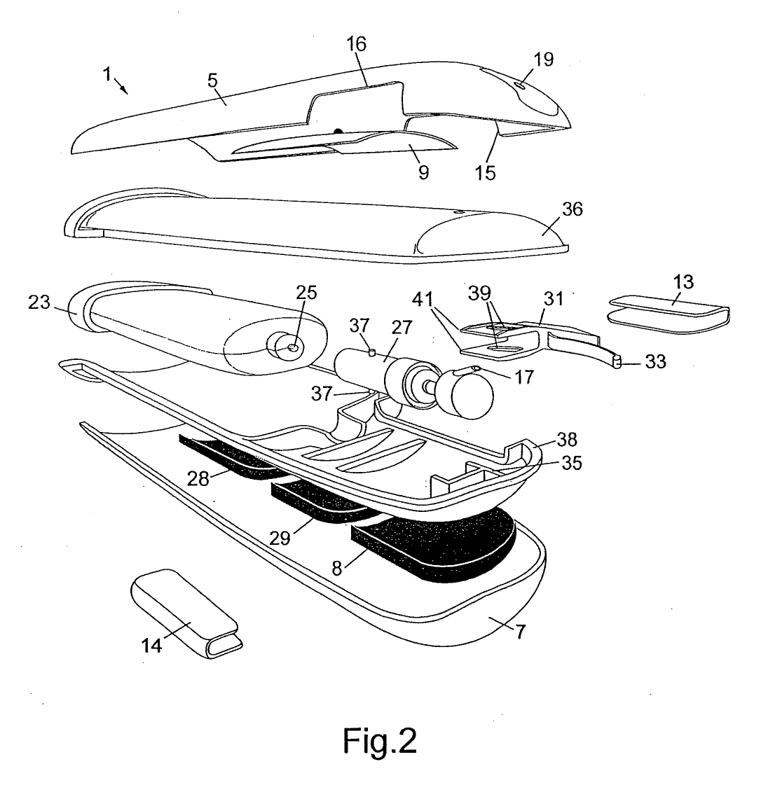

FIG. 2 is an exploded view of the dispenser of FIG. 1;

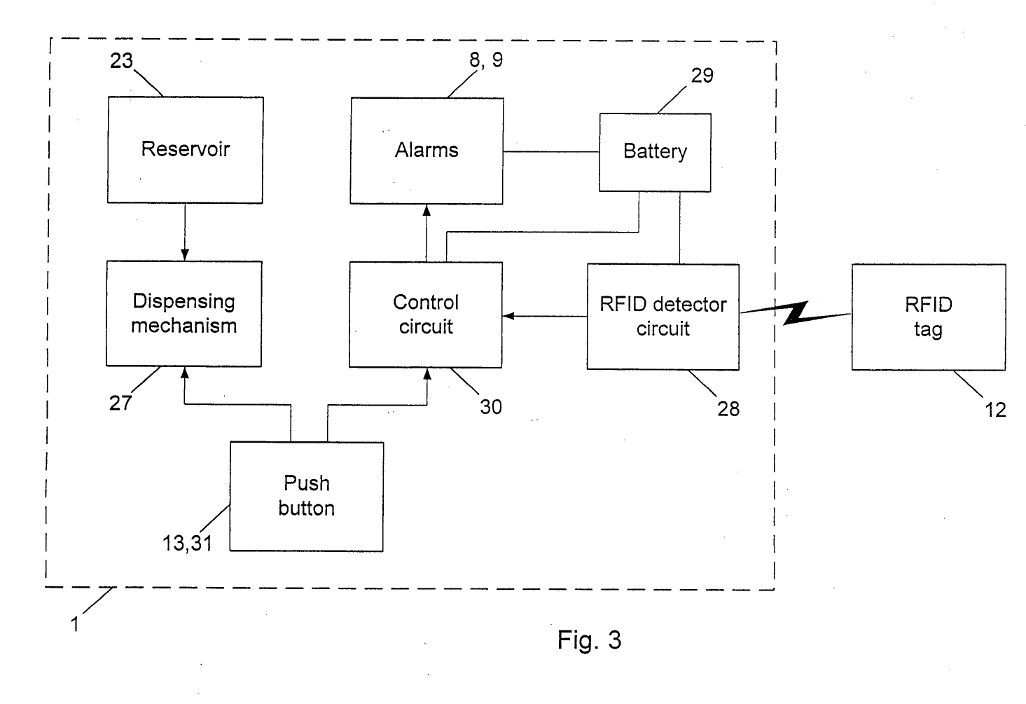

FIG. 3 is a block diagram of a dispenser system comprising the dispenser of FIG. 1;

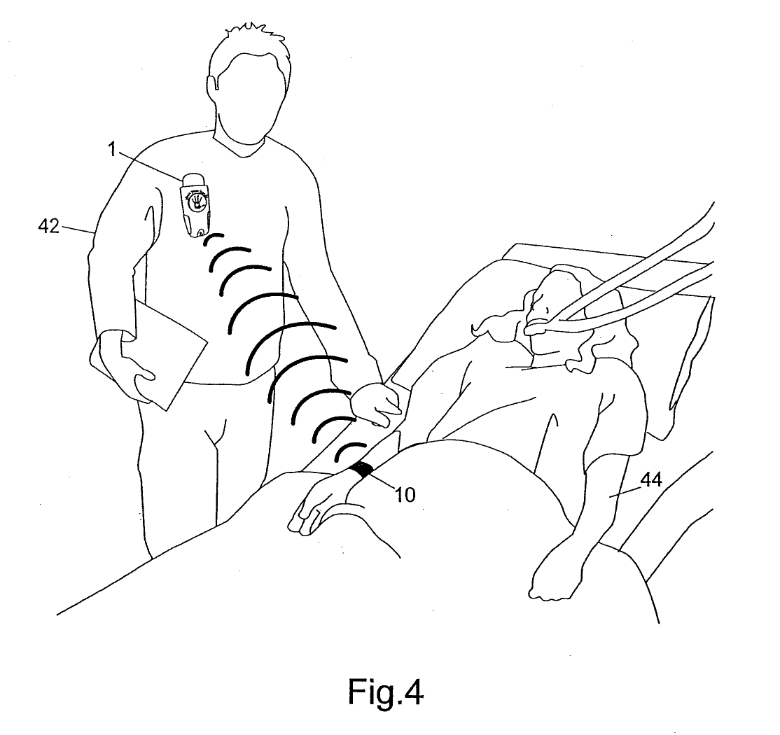

FIG. 4 shows the system of FIG. 3 in use by a nurse and a patient; and

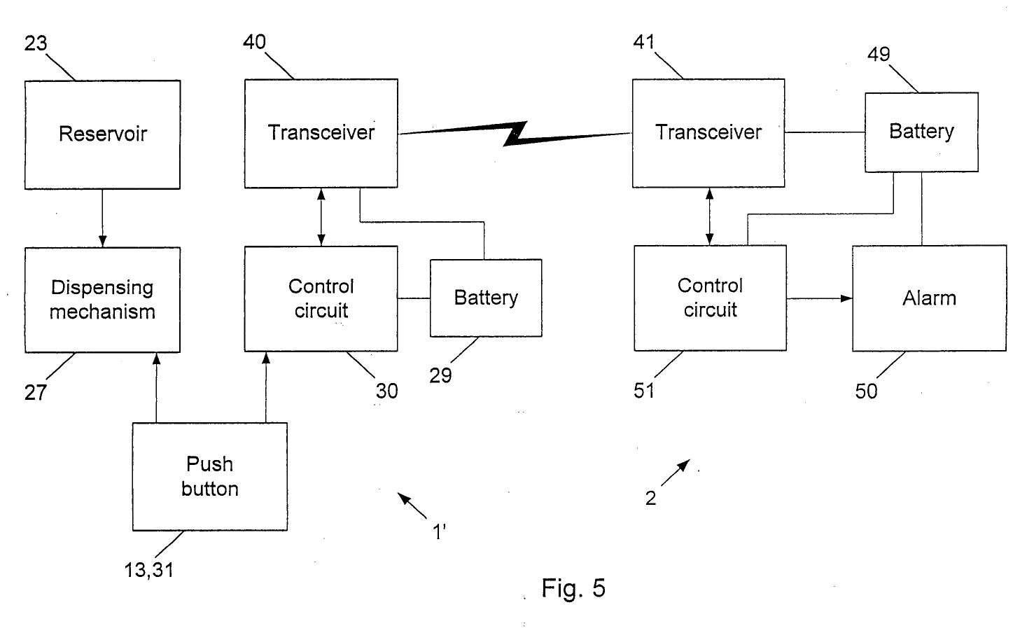

FIG. 5 is a block diagram of a dispenser system in accordance with a second embodiment of the invention.

Referring to FIGS. 1 and 2, a dispenser 1 comprises a housing 3 in the form of a front outer shell 5 and a rear outer shell 7. A translucent illumination circuit/visible alarm 9 partially protrudes through a cut-out 11 in the front outer shell 5. A flexible trigger skin 13 is provided in a lower side cut-out 15 of the front outer shell 5 and a similarly shaped grip panel 14 is provided in a second cut-out 16 on the opposed side of the front outer shell 5. The grip panel 14 in cooperation with the trigger skin 13 provide a convenient position for gripping the dispenser 1. A nozzle 17 protrudes through a hole 19 towards a base 21 of the front outer shell 5. A bottle/reservoir 23 containing anti-bacterial hand cleanser is inserted through an opening in the top of the housing 3.

Referring to FIG. 2, the bottle 23 is received within front 36 and rear 38 inner shell portions. An opening 25 in the bottle 23 mates with a dispensing mechanism/means 27 located towards the bottom of the inner shell portions 36, 38. The dispensing mechanism 27 is in the form of a longitudinally compressible device which conveys anti-bacterial hand cleanser from the reservoir 23 to the nozzle 17 of the dispensing mechanism 27 when the dispensing mechanism 27 is compressed.

The dispenser 1 further comprises a radio frequency identification (RFID) detector circuit 28, a battery 29, a vibrating alarm 8, an electro-mechanical switch (not shown) and a control circuit (not shown). The control circuit is electrically connected to the RFID detector circuit 28, the alarms 8, 9 and the electro-mechanical switch and is powered by the battery 29.

A trigger/actuation means 31 is disposed between the trigger skin 13 and the dispensing mechanism 27, the trigger 31 being partially disposed within the U-shaped trigger skin 13. The trigger 31 comprises a resilient spring finger 33 and first and second inwardly extending arms 41. The resilient finger 33 abuts an inner wall 35 of the rear inner shell 38 of the dispenser 1. First and second protrusions 37 on opposed sides of the dispensing mechanism 27 are located within elongate first and second cut-outs 39 in the respective first and second inwardly extending arms 41 of the trigger 31. The protrusions 37 and elongate cut-outs 39 are arranged such that when the trigger 31 is pushed towards the dispensing mechanism 27 the protrusions 37 ride along the elongate cut-outs 39 to compress the dispensing mechanism 27, thereby dispensing anti-bacterial hand cleansing hygiene product from the bottle 23 through the nozzle 17.

In addition to the trigger 31 activating the dispensing mechanism 27, the trigger 31 is also disposed proximal to the electro-mechanical switch so as to actuate the electro-mechanical switch when the trigger skin 13 is depressed.

Surface fastener strips, such as those marketed under the registered trade mark Velcro, are attached to the rear outer shell 7 of the dispenser 1, so that the dispenser 1 can be attached to cooperating surface fastener strips fixed to a garment of a healthcare professional.

The dispenser 1 operates in combination with one or more RFID tag. The RFID tag typically forms part of a wristband given to a patient on admission to the healthcare establishment. In this embodiment the RFID tag is a passive device. RFID technology is well known wherein an RFID detector can detect the presence of an RFID tag when the RFID tag is in range of the detector. Each patient is provided with a unique RFID tag such that the dispenser 1 detects each patient individually.

In operation, the dispenser 1 is worn by a healthcare professional by attaching the dispenser 1 to the clothing of the healthcare professional by means of the surface fastener strips. When the healthcare professional carrying the dispenser 1 is sufficiently close to a patient having a wristband comprising an RFID tag, the RFID detector 28 detects the presence of the target RFID tag and transmits a signal to the control means which activates the vibrating alarm 8 and the visible alarm 9. The vibrating alarm 8 alerts the healthcare professional carrying the dispenser 1 and the visible alarm 9 alerts the patient and possibly also the healthcare professional to the proximity of the healthcare professional to the patient. The activated alarms 8, 9 indicate that the healthcare professional should decontaminate their hands with anti-bacterial hand cleanser.

To deactivate the alarms 8, 9, the healthcare professional grips the dispenser 1 at the trigger skin 13 and the gripping panel 14 and depresses the push button trigger skin 13, thereby pushing the trigger 31 towards the dispensing mechanism 27 and depressing the electro-mechanical switch. When the trigger 31 is moved towards the dispensing mechanism 27 the pins 37 ride along the elongate cut-outs 39 to compress the dispensing mechanism 27 and dispense anti-bacterial hand cleanser from the bottle 23 through the nozzle 17. The dispensed anti-bacterial hand cleanser is then used by the healthcare professional to decontaminate their hands.

As stated above, when the trigger skin 13 is depressed to push the trigger 31 towards the dispensing mechanism 27, as well as compressing the dispensing mechanism 27 to dispense anti-bacterial hand cleanser from the nozzle 17, the trigger 31 also actuates the electro-mechanical switch. When the electro-mechanical switch is activated a signal is sent to the control circuit to indicate that the trigger skin 31 has been depressed and hence that anti-bacterial hand cleanser is being dispensed. The control circuit deactivates the alarms 8, 9 to effectively reset the dispenser 1. In this manner, the trigger skin 13 and trigger 31 combination act as both dispensing actuation means and alarm deactivation means for dispensing anti-bacterial hand cleanser and deactivating the alarm means 8, 9 respectively.

When the trigger 31 is pushed towards the dispensing mechanism 27, the spring finger 33 is pushed against the wall 35 of the rear inner shell 38, thereby biasing the trigger 31 to return its outer at-rest position. When the healthcare professional releases the trigger skin 13, the spring finger 33 urges the trigger 31 to its at-rest position thereby allowing the dispensing mechanism 27 to return to its extended at-rest state and also de-actuating the electro-mechanical switch.

When a healthcare professional carrying the dispenser 1 subsequently approaches a second patient, the RFID circuit 28 detects an RFID tag associated with the second patient and identifies this tag as a different tag to the first tag and hence the second patient as a different patient to the first patient. The control circuit activates the alarms 8, 9 of the dispenser 1, to indicate that the healthcare professional must once again decontaminate their hands. To deactivate the alarms 8, 9 the healthcare professional depresses the trigger skin 13 and consequently dispenses further anti-bacterial hand cleanser from the dispenser 1.

In this manner, as the healthcare professional carrying the dispenser 1 moves from one patient to a different patient the healthcare professional is prompted to dispense anti-bacterial hand cleanser and consequently decontaminate their hands each time a consecutively different patient is approached. Similarly, each approached patient is alerted by the visible alarm 9 that the healthcare professional needs to decontaminate their hands. This visible notification to the patient and the awareness of the healthcare professional that the patient has been notified by the visible alarm 9 that the healthcare professional should decontaminate their hands encourages the healthcare professional to decontaminate their hands in accordance with good practice and guidelines laid down by some healthcare providers.

FIGS. 3 and 4 show a dispenser system comprising the dispenser 1 of FIGS. 1 and 2 and an RFID tag 12 associated with a patient 44. The dispenser 1 is worn by a healthcare professional 42 and a wristband 10 comprising the RFID tag 12 is worn by the patient 44. As the healthcare professional 42 carrying the dispenser 1 approaches the patient 44 the dispenser 1 is brought within a detectable range of the RFID tag 12 in the wristband 10 and the alarms 8, 9 in the dispenser 1 are activated.

Bottles of hygiene product typically contain between 40 and 50 millilitres of anti-bacterial hand gel. When the reservoir 23 of anti-bacterial hand cleanser has been exhausted, the bottle 23 is removed and replaced with a new bottle of hygiene product.

Various modifications will be apparent to those in the art and it is desired to include all such modifications as fall within the scope of the accompanying claims.

For example, the dispensing actuation means and the alarm deactivation means may each be comprised of separate push buttons. Instead of a push button or buttons, other known actuating mechanisms can be used. The RFID tag may be an active tag or a semi-passive tag. The detecting means may comprise detecting means other than RFID based technology, for example other means of electromagnetic based technology such as Bluetooth® or infrared signals. The alarm means may comprise one or more of a visible alarm, an audible alarm and a vibrating alarm.

The control means may comprise a microprocessor. The control means may be programmed to actuate the alarm means at a predetermined time after the detecting means detects the targets, so that if a healthcare professional exclusively attends to the same patient over a predetermined time then the alarm means will be activated to prompt the healthcare professional to once again decontaminate their hands.

The control means may be programmed to behave differently for different patients. For example, the unique identifier associated with a patient may contain data about the medical condition of the patient. This data may include a grade of illness depending on the seriousness of the condition of the patient. If a patient is identified as being seriously ill then the control means may be programmed to activate the alarm means at an increased distance from the patient, to reflect the greater level of risk of infection associated with the patient. Conversely, if a patient has a low risk of infection associated with a mild illness then the control means may be programmed to activate the alarm means at a decreased distance from the patient, to reflect the lower level of risk of infection associated with that patient. Similarly, if the patient is identified as being seriously ill, the control means may be programmed to repeatedly activate the alarm means at an increased frequency when the health professional is continuously caring for the same patient.

The invention is not limited to the dispensing mechanism 27 described above and any suitable dispensing mechanism can be used. The invention is not limited to anti-bacterial hand gel but any suitable decontaminating substance, whether liquid, gel, powder or solid, can be used with a suitable dispenser.

Alternative mounting means can be used to allow the dispenser 1 to be carried by a healthcare professional. For example, instead of using surface fastener type strips to attaché the dispenser 1 to a garment of a healthcare professional, a hook or loop can be used to attach the dispenser 1 to a belt of the healthcare professional or to a pocket of a garment of the healthcare professional.

The dispenser 1 may be disposed proximal to each patient and each healthcare professional may be provided with an RFID tag so that as each healthcare professional approaches a patient the alarm means in the dispenser 1 proximal to the patient is triggered to activate the alarm or alarms and prompt the approaching healthcare professional to deactivate the alarm by dispensing hygiene product from the dispenser and decontaminate the healthcare professional's hands.

FIG. 5 is a block diagram of a second dispenser system embodying the invention. According to this embodiment a dispenser 1 is located on the person of the healthcare professional and an alarm unit 2 is disposed proximal to the patient. The dispenser 1 comprises a dispensing mechanism 27 in communication with a reservoir 23, similar to the arrangement of the first embodiment of FIGS. 1 to 4. The dispensing mechanism 27 is actuated by depressing a push button 13, 31 which also activates an electro-mechanical switch (not shown) connected to a control circuit 30. The control circuit is connected to a transceiver 40 and the control circuit 30 and the transceiver 40 are both powered by a battery 29. The transceiver 40 communicates using the Bluetooth® communication protocol.

The alarm unit 2 comprises a visible and audible alarm 50 which is controlled by a control circuit 51. A transceiver 41 is connected to the control circuit 51. The transceiver 41, control circuit 51 and alarm 50 are powered by a battery 49. The transceiver 41 operates using the same protocol as the transceiver 40 of the dispenser 1′.

In operation, when a healthcare professional carrying the dispenser 1′ approaches an alarm unit 2 associated with a patient, the transceiver 41 of the alarm unit 2 detects the presence of the transceiver 40 of the dispenser 1′ and the transceiver 41 sends a signal to the control circuit 51 which triggers the alarm 50.

The healthcare professional is prompted by the alarm 50 to decontaminate their hands. The healthcare professional depresses the push button 13, 31 to dispense hygiene product from the reservoir 23 by means of the dispensing mechanism 27 while at the same time actuating the electro-mechanical switch to send a signal to the control circuit 30. The control circuit 30, detecting the depression of the push button 13, 31 to dispense hygiene product from the dispensing mechanism 27 sends a signal to the transceiver 40 to communication with the transceiver 41 of the alarm unit 2. The transceiver 41 receives the signal from the transceiver 40 of the dispenser 1′ and sends a signal to the control circuit 51. On receipt of the signal from the transceiver 41, the control circuit 51 deactivates the alarm 50.

The alarm unit 2 associated with each patient has a unique identifier so that as the healthcare professional carrying the dispenser 1′ approaches each different patient and their associated alarm unit 2, the alarm unit 2 is activated thereby prompting the healthcare professional to decontaminate their hands.

In this second embodiment the system is arranged such that the dispenser 1′ is located on the person of the healthcare professional and the alarm unit 2 is proximal to the patient. In an alternative embodiment the alarm unit 2 is carried by the healthcare professional and the dispenser 1′ is located proximal to the patient and each dispenser 1′ associated with each patient has a unique identifier.

Various modifications will be apparent to those in the art and it is desired to include all such modifications as fall within the scope of the accompanying claims.

1-33. (canceled)

34. A dispenser system comprising:
detecting means;
alarm means activatable when the detecting means detects a target;
alarm deactivation means for deactivating the alarm means; and
dispense actuation means for actuating dispensing means,
wherein the dispense actuation means is operable to actuate the dispensing means in response to deactivation of the alarm means and/or the alarm deactivation means is operable to deactivate the alarm means in response to actuation of the dispensing means.

35. A dispenser system according to claim 34 wherein the alarm means and dispensing means are contained in a single unit which may be carried by a user.

36. A dispenser system according to claim 34 comprising a dispenser and a separate alarm unit, the dispenser comprising the dispense actuation means, and the alarm unit comprising:
the detecting means for detecting the dispenser;
the alarm means activatable when the detecting means detects the dispenser; and
the alarm deactivation means for deactivating the alarm means.

37. A dispenser system as claimed in claim 34 wherein the alarm deactivation means and the dispensing actuation means comprise a single actuating mechanism.

38. A dispenser system as claimed in claim 34, wherein the detecting means comprises a radio frequency identification (RFID) tag detector and the target is an RFID tag.

39. A dispenser system as claimed in claim 38, wherein the RFID tag is a passive RFID tag.

40. A dispenser system as claimed in claim 34, wherein the detecting means comprises a transceiver associated with the alarm means and a transceiver associated with the target.

41. A dispenser system as claimed in claim 34, wherein the detecting means comprises a transceiver associated with the alarm means and a transceiver associated with the dispensing means.

42. A dispenser system comprising: a dispenser and an alarm unit, wherein the dispenser comprises dispensing means, and wherein the alarm unit comprises detecting means for detecting the dispenser and alarm means activatable when the detecting means detects the dispenser.

43. A dispenser system according to claim 42 wherein the dispenser comprises dispense actuation means for actuating the dispensing means, the alarm unit comprises alarm deactivation means for deactivating the alarm means, and wherein the dispense actuation means is operable to actuate the dispensing means in response to deactivation of the alarm means and/or the alarm deactivation means is operable to deactivate the alarm means in response to actuation of the dispensing means.

44. A dispenser system as claimed in claim 42, wherein the detecting means comprises a first transceiver; and
the dispenser comprises a second transceiver for communicating with the first transceiver.

45. A dispenser system as claimed in claim 44, wherein the alarm means is activatable when the first transceiver receives a first signal from the second transceiver.

46. A dispenser system as claimed in claim 45, wherein the alarm means is deactivatable when the first transceiver receives a second signal from the second transceiver.

47. A dispenser system as claimed in claim 46, wherein the second signal is sent when the dispensing means dispenses a substance.

48. A dispenser system as claimed in claim 34 or claim 42 for dispensing a hygiene product, wherein the alarm deactivation means is operable to deactivate the alarm means when a hygiene product is dispensed from the dispensing means and/or the dispense actuation means is operable to dispense a hygiene product actuate in response to deactivation of the alarm means.

49. A dispenser system as claimed in claim 34 or claim 42, wherein the alarm means comprises one or more of a visible alarm, an audible alarm and a vibrating alarm.

50. A dispenser system as claimed in claim 34 or claim 42, further comprising control means for controlling the detecting means and the alarm means.

51. A dispenser system as claimed in claim 50, wherein the control means comprises a control circuit.

52. A dispenser system as claimed in claim 50, wherein the control means comprises a microprocessor.

53. A dispenser system as claimed in claim 50, wherein the control means is operable to activate the alarm means each time the detecting means detects a target/dispenser within a predetermined distance.

54. A dispenser system as claimed in claim 50, wherein the control means is operable to activate the alarm means at a predetermined time after the detecting means detects a target/dispenser.

55. A dispenser system as claimed in 50, wherein the control means is operable to deactivate the alarm in response to the alarm deactivation means.

56. A dispenser system as claimed in claim 34 or claim 42, further comprising means for receiving a hygiene product.

57. A dispenser system as claimed in claim 56, wherein the hygiene product is in a removable container.

58. A dispenser system as claimed in claim 56, wherein the hygiene product is a liquid, gel, solid or powder.

59. A dispenser system as claimed claim 56, wherein the hygiene product is an anti-bacterial hand rub.

60. A dispenser system as claimed in claim 34 or claim 42, further comprising mounting means for mounting at least part of the dispenser system on a garment.

61. A dispenser system as claimed in claim 60, wherein the mounting means is associated with the dispensing means.

62. A dispenser system as claimed in claim 60, wherein the mounting means is associated with the alarm means.
